(19) United States
(12) Patent Application Publication
(10) Pub. No.: US 2026/0044944 A1
(43) Pub. Date: Feb. 12, 2026

(54) AUTOMATED METHOD TO DETECT BLURRINESS AND SATURATED PIXELS FROM IMAGES

(71) Applicant: SCHLUMBERGER TECHNOLOGY CORPORATION, Sugar Land, TX (US)

(72) Inventor: Matthias FRANCOIS, Clamart (FR)

(21) Appl. No.: 19/141,071

(22) PCT Filed: May 31, 2024
(86) PCT No.: PCT/US2024/031966

§ 371 Date: Jun. 19, 2025

(30) Foreign Application Priority Data
May 31, 2023 (EP) 23305862.7

(51) Int. Cl. G06T 7/00

(52) U.S. Cl. CPC G06T 7/0002; G06T 2207/20084; G06T 2207/30168; G06T 2207/30181

(57) ABSTRACT

Systems and methods are provided for analyzing sample images, such as for cuttings obtained during drilling of a geologic formation. The system utilizes automated image processing to detect and correct blurriness and saturated pixels in the sample images and control related devices based on the detection. The system allows the acquisition of high quality logging curves for real-time and/or near real-time geologic formation evaluation and geosteering.

### CROSS REFERENCE PARAGRAPH

This application claims the benefit of U.S. Provisional Application No. 61/081,621, entitled “METHOD FOR DETERMINING HYDROCARBON IN PRESENCE OF ELECTRON AND CHEMICAL IONIZATION,” filed Aug. 17, 2023, the disclosure of which is hereby incorporated herein by reference.

### BACKGROUND

The present disclosure relates generally to a method and system for analyzing sample images, such as for cuttings obtained during drilling of a geologic formation. In particular, the present disclosure relates to utilizing automated image processing to detect blurriness and saturated pixels in sample images.

During the drilling process of an oil well or of a well of another effluent—in particular gas, vapor or water—cuttings are brought to the surface after they have been cut from the geologic formation by a drilling bit and brought to surface by a mud circulating in the wellbore. An analysis may be performed on the cuttings to enable the creation of a detailed record (e.g., a master log) of the geologic formations of a wellbore. The detailed record may be a function of the wellbore depth and may enable a determination of various wellbore information, for example, the lithology of the geologic formation.

Generally, the sample images are analyzed by a geologist to determine the nature of the cuttings, so as to determine the lithology of the geologic formation from which the cuttings are extracted. However, such work takes a substantial amount of time and is generally performed in a lab away from the drilling installation, which makes it less efficient to control the drilling process based on the results of the analysis. Further, such work is highly subjective as it is based on human observation. Therefore, it is desirable to have an improved method to analyze the sample images.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Certain embodiments of the present disclosure include a system that may include a processor and memory storing instructions, and the instructions may cause the processor to perform operations including receiving image data of an image of rock samples from an imaging system, and the image data comprise a plurality of image pixels associated with a plurality of gray levels; detecting a proportion of image pixels having gray levels in a particular range in the image data; determining whether the image is qualified for an image analysis process by comparing the proportion with a threshold value; in response to the determination that the image is qualified for the image analysis process, identifying lithology of the rock samples; generating a record based on the lithology of the rock samples; and controlling a device associated with acquiring the rock samples based on the record.

Certain embodiments of the present disclosure include a computer-implemented method that may include receiving image data of an image of rock samples from an imaging system, and the image data comprise a plurality of image pixels associated with a plurality of gray levels; detecting a proportion of image pixels having gray levels in a particular range in the image data; determining whether the image is qualified for an image analysis process by comparing the proportion with a threshold value; in response to the determination that the image is qualified for the image analysis process, identifying lithology of the rock samples; generating a record based on the lithology of the rock samples; and controlling a device associated with acquiring the rock samples based on the record.

Certain embodiments of the present disclosure include a system that may include a drilling system used to acquire rock samples from a wellbore and a geological analysis system used to identify lithology of the rock samples. The geological analysis system may include a preparation device configured to prepare the rock samples, an imaging system configured to take an image of the rock samples, and an analysis system configured to analyze an image quality of the image and identify lithology of the rock samples.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a schematic diagram of a drilling installation comprising a geological analysis system, in accordance with aspects of the present disclosure;

FIG. 2 is a flowchart of a method for generating a detailed record for the system of FIG. 1, in accordance with aspects of the present disclosure;

FIG. 3 is a plot for a portion of a detailed record generated by using the method in FIG. 2, in accordance with aspects of the present disclosure;

FIG. 4 is a flowchart of a method for analyzing image quality, in accordance with aspects of the present disclosure;

FIG. 5 is a comparison of image saturation of two images, in accordance with aspects of the present disclosure; and

FIG. 6 is a comparison of blurriness of two images, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “connect,” “connection,” “connected,” “in connection with,” and “connecting” are used to mean “in direct connection with” or “in connection with via one or more elements”; and the term “set” is used to mean “one element” or “more than one element.” Further, the terms “couple,” “coupling,” “coupled,” “coupled together,” and “coupled with” are used to mean “directly coupled together” or “coupled together via one or more elements.”

In addition, as used herein, the terms “real-time”, “real-time”, or “substantially real-time” may be used interchangeably and are intended to described operations (e.g., computing operations) that are performed without any human-perceivable interruption between operations. For example, data relating to the systems described herein may be collected, transmitted, and/or used in control computations in “substantially real-time”, such that data readings, data transfers, and/or data processing steps may occur once every second, once every 0.1 second, once every 0.01 second, or even more frequent, during operations of the systems (e.g., while the systems are operating). In addition, as used herein, the terms “automatic” and “automated” are intended to describe operations that are performed are caused to be performed, for example, solely by analysis system without human intervention.

The present disclosure relates to a system and method for analyzing images of cutting samples taken by a drilling system from a geologic formation. The cutting samples have been cut from the geologic formation during drilling and may be used to evaluate the geologic formation and characterize one or several of its properties, such as its mineralogy, lithology, porosity, density, etc., based on a position (e.g., X, Y, Z coordinates and/or depth) in the geologic formation. For example, the images of the cutting samples may be used to identify lithology of the rocks in the cutting samples and predict characteristics and parameters for the geologic formation. The lithology of the rock samples may be used to generate a detailed record (e.g., a master log file) for the geologic formation. The detailed record may include information regarding the geologic properties (e.g., lithology, layer, depositional environments) and petrophysical characterization (e.g., water saturation, porosity, permeability, volume of shale) of the geologic formation, which may be used to control the drilling system or a drilling plan of the drilling system. The qualities of the images may vary (e.g., brightness, blurriness, etc.), and some of the images may not have the appropriate image quality for the image analysis, which may cause less efficient image analyzing process and/or less accurate results. Accordingly, it is desirable to detect the image quality before sending the image to the analysis system for a detailed analysis.

An image may be divided into small geometrical subunits called image pixels, which include image data corresponding to the image content. Depending on the content of the image, the image data may include different color channels, such as red channel image data indicative of target luminance of a red color, blue channel image data indicative of target luminance of a blue color, green channel image data indicative of target luminance of a green color, or grayscale image data indicative of target luminance of a gray color. The image data corresponding with the image content are indicative of target visual characteristics (e.g., luminance and/or color) at one or more specific points (e.g., image pixels) in the image content, for example, by indicating color channel brightness levels (e.g., gray levels).

Gray levels are discrete levels (e.g., 0, 1 . . . 255) corresponding to quantized light brightness (e.g., light brightness of color channels, light brightness of gray color) at the image pixels. For example, the brightness level may be at maximum when the gray level has a value of 255 and minimum when the gray level has a value of 0. The relationship between the gray level of the image pixels and the corresponding brightness at the image pixels is associated with the imaging system used to take the image. For instance, the gray levels generally may have a nonlinear relationship with respect to the brightness of the image pixels, especially at either the minimum or the maximum of gray levels in its neighborhood. For example, when the gray level is in a range close to the maximum value (e.g., first or near maximum range), changes in the gray level may not correspond to changes in the brightness of the image pixels, which corresponds to image saturation. When an image pixel is saturated, the differences in the brightness of the image pixel may be difficult to detect. On the other hand, when the gray level is in a range close to the minimum value (e.g., second or near minimum range), changes in the gray level may also not correspond to changes in the brightness of the image pixels. To make the image processing/analyzing more efficient and obtain more accurate results, the qualities of the images may be defined so that the gray levels used in the images generally avoid these two ranges. In some embodiments, the images having gray levels in the two ranges (e.g., first and second ranges) may be processed so that the qualities of the images may be improved to satisfy the requirement of the analysis system.

Another factor of image quality is image blurriness, which may be caused by a number of reasons, such as improper focus on the subject, motion of the camera and/or motion of the subject during exposure, etc. A blurry index may be used to describe the degree of blurriness. For example, when the blurry index has a value less than a predefined value, which may be associated with the image processing system, the visual characteristics (e.g., luminance and/or color) in the image may be difficult to detect. To make the image processing/analyzing more efficient and obtain more accurate results, the qualities of the images may be defined so that the blurry indexes used in the images are generally greater than the predefined value. In some embodiments, the images having local blurry indexes less than the predefined value may be processed so that the qualities of the images may be improved to satisfy the requirement of the analysis system.

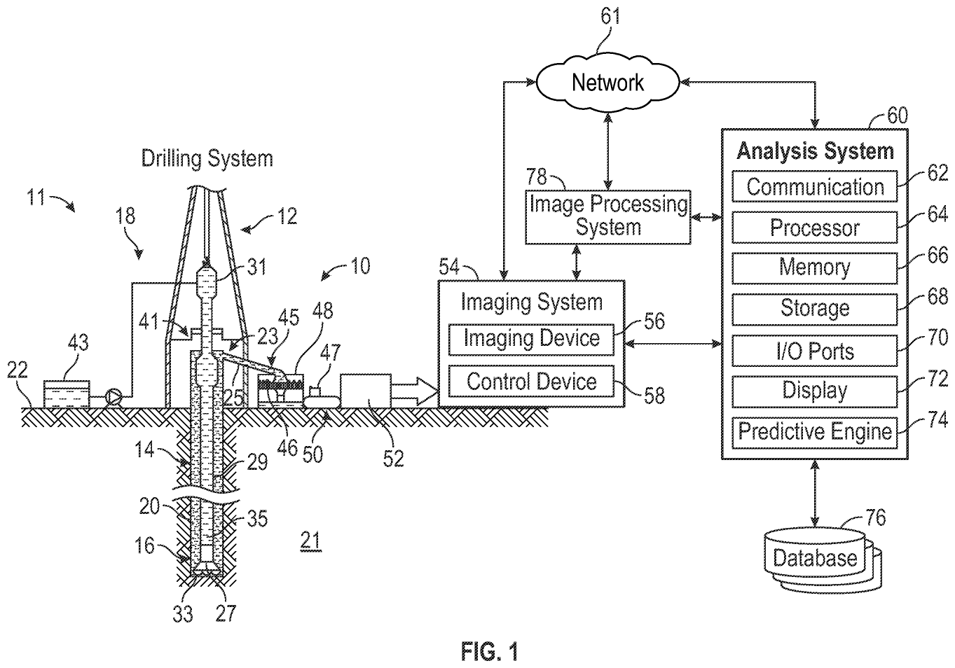

With forgoing in mind, FIG. 1 illustrates an example oil and gas worksite 10 with a geological analysis system 11 used for analysis and control with a drilling system 12. The drilling system 12 includes a rotary drilling tool 14 drilling a cavity 16; a surface installation 18, where drilling pipes are placed in the cavity 16. A wellbore 20 (e.g., wellbore), delimiting the cavity 16, is formed in the substratum 21 by the rotary drilling tool 14. At the surface 22, a well head 23 having a discharge pipe 25 closes the wellbore 20. The drilling tool 14 includes a drilling head 27, a drill string 29 and a liquid injection head 31. The drilling head 27 includes a drill bit 33 for drilling through the rocks of the substratum 21. The drilling head 27 is mounted on the lower portion of the drill string 29 and is positioned in the bottom of the wellbore 20. The drill string 29 includes a set of hollow drilling pipes. These pipes delimit an internal space 35, which makes it possible to bring a drilling fluid from the surface 22 to the drilling head 27. The liquid injection head 31 is mounted (e.g., threaded, bolted, etc.) onto the upper portion of the drill string 29. The drilling fluid includes a drilling mud, such as a water-based or oil-based drilling mud.

The surface installation 18 includes a support 41 for supporting the drilling tool 14 and driving it in rotation, an injector 43 for injecting the drilling fluid and a shale shaker 45. The injector 43 is hydraulically connected to the injection head 31 to introduce and circulate the drilling fluid in the internal space 35 of the drill string 29. The shale shaker 45 collects the drilling fluid flowing out from the discharge pipe 25. The drilling fluid is charged with drilling residues, known as cuttings. The shale shaker 45 includes a sieve 46 allowing the separation of the solid drilling cuttings, such as rock samples 47, from the drilling mud. The shale shaker 45 also includes an outlet 48 for evacuating the rock samples 47. The rock samples 47 obtained at the outlet 48 have been cut from the geologic formation during drilling and may be used to evaluate the geologic formation and characterize one or several of its properties, such as its mineralogy, lithology, porosity, density, etc.

In the embodiment shown in FIG. 1, the rock samples 47 may be automatically or manually sampled and transferred to a conveyor 50, which may transfer the rock samples 47 to a preparation device 52. The preparation device 52 may prepare the rock samples 47 before sending them to an imaging system 54 manually or automatically (e.g., via a conveyance device). The geological analysis system 11 may include all equipment associated with acquiring, preparing, imaging, and analyzing the rock samples 47. For example, the geological analysis system 11 may include the shale shaker 45, the conveyor 50, the preparation device 52, the imaging system 54, an analysis system 60, and an image processing system 78. The preparation may include washing, rinsing, drying, or sieving the sample of rocks, etc. The imaging system 54 may include an imaging device 56 to take images of the rock samples 47. The imaging device 56 may be any type of optical or electronic microscope, camera, etc. The images obtained by the imaging device 56 may be digital images, which can be automatically analyzed as discussed in further detail below. The examples below are given with cameras detecting visible light spectrum, but the same methods may be applied to an image taken with infrared (IR) or ultraviolet (UV) camera detecting light in UV or IR domains. The imaging system 54 may also include a control device 58 (e.g., processor-based controller) to control the imaging device 56 and operational conditions (e.g., lighting, temperature, moisture) associated with the image taking process inside the imaging system 54. For example, the control device 58 may adjust the parameters (e.g., focus, exposure, shutter speed, brightness and color, contrast, filter, resolution, zooming) of the imaging device 56. The preparation device 52 and/or the imaging system 54 may be located at the oil and gas work site 10, or at one or more remote locations.

An analysis system 60 may be used to receive and analyze image data (e.g., digital images) from the imaging system 54 directly or via a network 61. The analysis system 60 may be located at the oil and gas work site 10, or at one or more remote locations. The analysis system 60 may include a communication component 62, a processor 64, a memory 66, a data storage 68, input/output (I/O) ports 70, a display 72, a predictive engine 74, and the like. The network 61 may include transceivers, receivers, and/or transmitters to facilitate data communication to and/or from the analysis system 60. For example, image data from the imaging system 54 may be transmitted to the analysis system 60 through the network 61. Further, external data (e.g., data about a geologic formation) may be gathered from a remote system and transmitted to the analysis system 60 via the network 61. However, in some embodiments, data may be transmitted directly from the devices (e.g., the imaging system 54) to the analysis system 60. Indeed, the analysis system 60 may communicate with the devices directly and/or through the network 61 in accordance with present embodiments. In certain embodiments, the data (e.g., image data) may be automatically communicated from the imaging system 54 to the analysis system 60 for analysis in real-time, thereby enabling real-time responses (e.g., adjusting imaging system 54, retaking images that are unacceptable, adjusting drilling system 12, etc.) to information obtained from analysis of the data.

The communication component 62 may be a wireless or wired communication component (e.g., circuitry) that may facilitate communication between the analysis system 60, various types of devices, the network 61, and the like. Additionally, the communication component 62 may facilitate data transfer to the analysis system 60, such that the analysis system 60 may receive data from the other components depicted in FIG. 1 and the like. The communication component 62 may use a variety of communication protocols, such as Open Database Connectivity (ODBC), TCP/IP Protocol, Distributed Relational Database Architecture (DRDA) protocol, Database Change Protocol (DCP), HTTP protocol, other suitable current or future protocols, or combinations thereof.

The processor 64 may include single-threaded processor(s), multi-threaded processor(s), or both. The processor 64 may process instructions stored in the memory 66. The processor 64 may also include hardware-based processor(s) each including one or more cores. The processor 64 may include general purpose processor(s), special purpose processor(s), or both. The processor 64 may be communicatively coupled to other internal components (such as the communication component 62, the data storage 68, the I/O ports 70, and the display 72).

The memory 66 and the data storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. As used herein, applications may include any suitable computer software or program that may be installed onto the analysis system 60 and executed by the processor 64. The memory 66 and the data storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 may be interfaces that may couple to other peripheral components such as input devices (e.g., keyboard, mouse), sensors, input/output (I/O) modules, and the like. The display 72 may operate as a human machine interface (HMI) to depict visualizations associated with software or executable code being processed by the processor 64. The display 72 may display a map of the geological formation data (e.g., images and information derived from the images) corresponding to positions on the map, alerts/alarms when image data is not acceptable, recommendations associated with the alerts/alarms, etc. In one embodiment, the display 72 may be a touch display capable of receiving inputs from an operator of the analysis system 60. The display 72 may be any suitable type of display, such as a liquid crystal display (LCD), plasma display, or an organic light emitting diode (OLED) display, for example. Additionally, in one embodiment, the display 72 may be provided in conjunction with a touch-sensitive mechanism (e.g., a touch screen) that may function as part of a control interface for the analysis system 60.

The predictive engine 74 may use various machine learning algorithms to analyze images obtained for the rock samples 47 to identify lithology of the rock samples. The predictive engine 74 may utilize one or more predictive models for analysis of the variety of data received by the analysis system 60. Various types of predictive models may be used to analyze data from variety of resources and generate predictive outputs. For example, the predictive engine 74 may be trained with supervised machine learning technique, i.e., a predictive model is trained with training data that includes input data and desired predictive output (e.g., labeled dataset). The predictive engine 74 may also be trained with unsupervised machine learning technique, i.e., a predictive model is trained with training data that includes input data but without desired predictive output (e.g., unlabeled dataset). The predictive engine 74 may include various types of artificial neural networks (ANN), such as Convolution Neural Networks (CNN), Recurrent Neural Networks (RNN), etc. The analysis system 60 may also communicate with a database 76, which may store information associated with the oil and gas work site 10, the drilling system 12, related external resources (e.g., geologic formation history), etc.

It should be noted that the components described above with regard to the analysis system 60 are exemplary components and the analysis system 60 may include additional or fewer components as shown. In addition, although the components are described as being part of the analysis system 60, the components may also be part of any suitable computing device described herein such as the sieve 46, the conveyor 50, the preparation device 52, the imaging device 56, the control device 58, an image processing system 78 coupled to the imaging system 54 and the analysis system 60, and the like to perform the various operations described herein.

The image processing system 78 may be used to receive and analyze image data from the imaging system 54 or the analysis system 60 directly or via the network 61. In some embodiments, the image processing system 78 may be included in the analysis system 60, or the imaging system 54, or both. The image processing system 78 may apply various image processing algorithms (e.g., Fast Fourier Transform (FFT), Single Value Decomposition (SVD) transform, Discrete Cosine Transform (DCT)) or software to modify the visual characteristics (e.g., luminance, color, contrast, sharpness) of images, or recognize certain characteristics (e.g., shapes, textures, colors, sizes) in images, or modify the images to obtain target visual effects, etc. The characteristics in images may be used to identify lithology of the rock samples 47. For example, the rock samples 47 in different rock categories may show different characteristics (e.g., shapes, textures, colors, sizes) on the image, and the image processing system 78 may analyze the image to identify the characteristics to determine the rock categories in the rock samples 47.

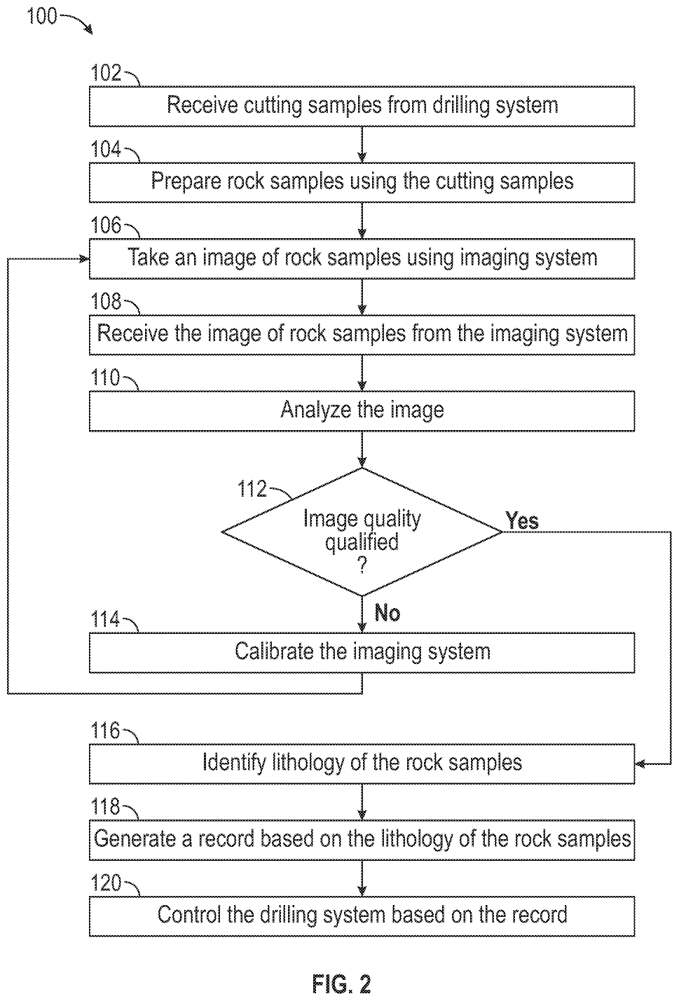

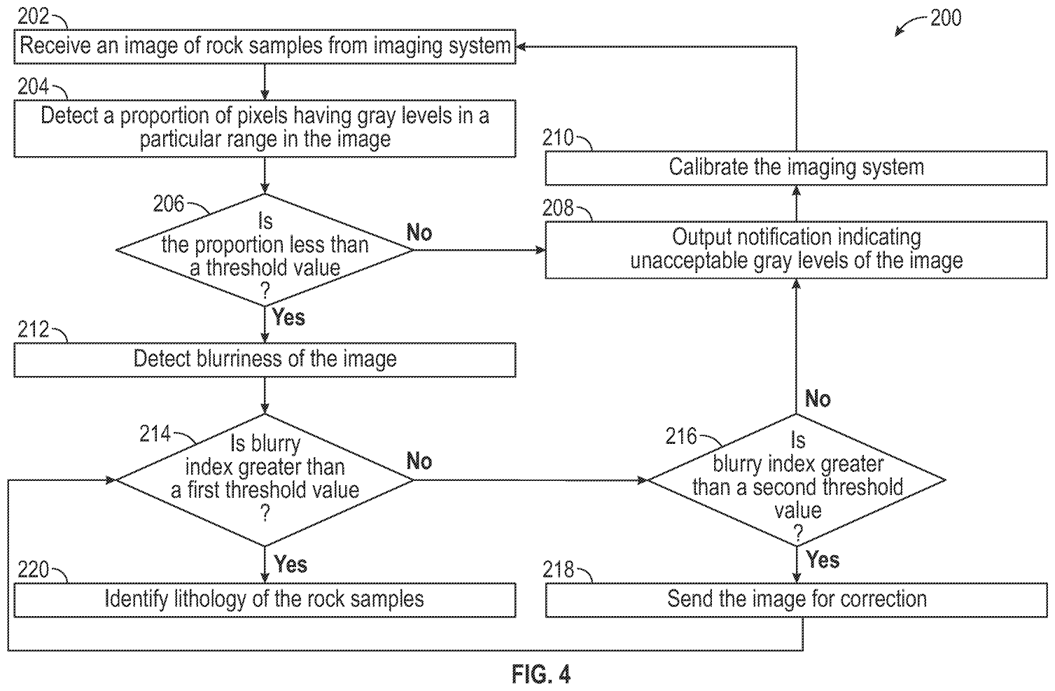

FIG. 2 is a flowchart of a computer-implemented method 100 for generating a detailed record (e.g., a master log) for the system of FIG. 1. For example, the method 100 may be implemented using one or more processor-based systems (e.g., processor-based controllers) configured to control the drilling system 12, the imaging system 54, the analysis system 60, the image processing system 78, and associated equipment of the oil and gas worksite 10. At block 102, cutting samples at a depth of the wellbore 20 may be received from the drilling system 12. At block 104, as described above, the shale shaker 45 may separate the solid cutting samples from the drilling mud via the sieve 46 to obtain the rock samples 47. The rock samples 47 may be delivered (e.g., via the conveyor 50) to the preparation device 52, which may prepare the rock samples 47 before sending them to the imaging system 54. The preparation may include washing, rinsing, drying, or sieving the sample of rocks, etc. At block 106, the imaging system 54 may take an optical image of the rock samples 47 by using the control device 58 to control the imaging device 56. At block 108, the analysis system 60 may receive the image of the rock samples from the imaging system 54. At block 110, the analysis system 60 may analyze the images of the rock samples to check the image quality by calculating multiple parameters (e.g., image saturation, image blurriness) associated with the image, as described in detail in FIG. 4. The analysis system 60 may utilize the image processing system 78 to analyze the image of the rock samples. At block 112, the analysis system 60 may determine the quality of the image by comparing the parameters associated with the image with their corresponding threshold values, which may be predetermined (e.g., based on operation requirements of the analysis system 60 or drilling targets).

If the image quality of the image is not qualified (e.g., the parameters associated with the images do not satisfy the threshold values), at block 114, the analysis system 60 may output a notification (e.g., audio and/or visual alert) and send an instruction to the imaging system 54 to calibrate the imaging system based on the offset of the parameters of the image from their corresponding threshold values. The analysis system 60 may send instruction to the control device 58 to adjust the operational parameters of the imaging device 56, such as the focus, the exposure, the shutter speed, the brightness and color, the contrast, the filters, the resolution, the zooming, and the like. For example, the analysis system 60 may send instruction to the control device 58 to adjust the focus of the imaging device 56 when the parameters indicate that the image is out of focus, and the adjustment may be variable based on the offset of the parameters from the corresponding threshold values. When the parameters indicate that the image is saturated or too dark, the analysis system 60 may send instruction to the control device 58 to adjust the exposure, the shutter, the brightness and color, the contrast, the filters, etc. of the imaging device 56. In addition, the control device 58 may also adjust the operational conditions of the imaging device 56, such as the ambient light, temperature, moisture of the imaging device 56. After the imaging system 54 is calibrated, the imaging system 54 may take another image of the rock samples. Thus, the blocks 106 to 112 may be repeated until the image quality is qualified.

If the image quality of the image is qualified (e.g., the parameters associated with the images satisfy the threshold values), at block 116, the analysis system 60 may use the image to identify lithology of the rock samples. The analysis system 60 may utilize the image processing system 78 to process the image to identify lithology of the rock samples. The analysis system 60 may also utilize the predictive engine 74 to identify lithology of the rock samples. For example, the predictive engine 74 may use a Convolution Neural Network (CNN) to detect characteristics of the image of the rock samples to identify lithology of the rock samples. The characteristics in the image may be associated with lithology of the rock samples 47. For example, the rock samples 47 in different rock categories may show different characteristics (e.g., shapes, textures, colors, sizes) on the image, and the predictive engine 74 may analyze the image to identify the characteristics to determine the rock categories in the rock samples 47. The predictive engine 74 may also compare the image against baseline images and/or images of known rock formations to better identify rock categories. The images could be compared by identifying colors, patterns, textures, etc., to get better accuracy of the identification of the lithology. The predictive engine 74 may also use historical wellbore formation data (e.g., data from other sites in the geologic area) to identify lithology of the rock samples and to predict the geologic formation of the wellbore 20.

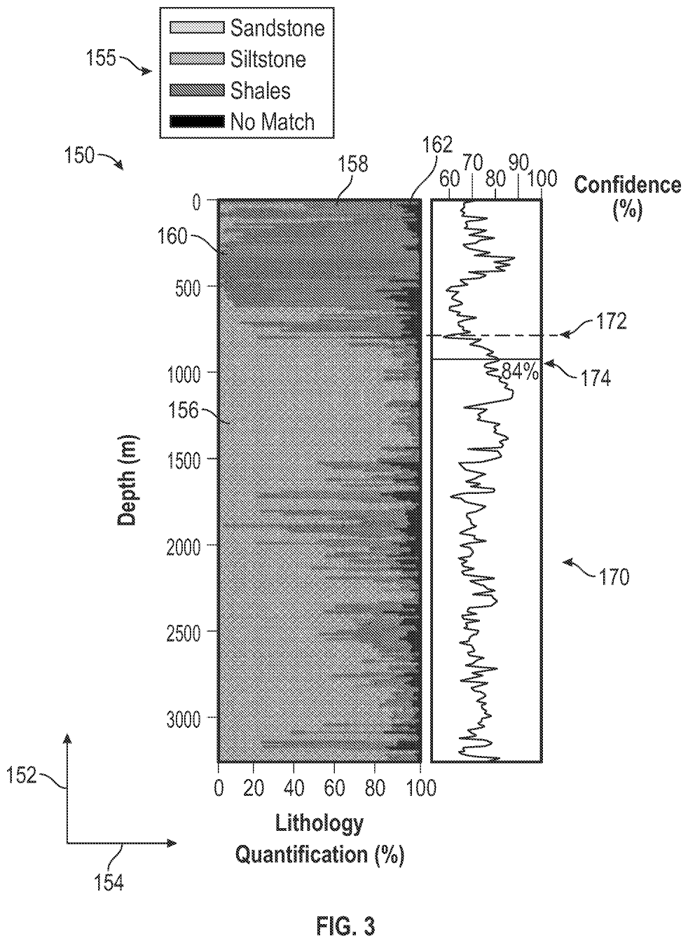

At block 118, the analysis system 60 may generate a detailed record (e.g., a master log file) based on the lithology of the rock for cutting samples from various locations indicated by corresponding coordinates (e.g., XYZ coordinates) in the wellbore 20, an example of the detailed record (e.g., from various depths along Z direction) is illustrated in FIG. 3. The detailed record includes information of the geologic formation, which may be used to control the drilling system 12 and/or drilling plans of the drilling system 12 at block 120. To obtain accurate results, a great amount of images of the rock samples may be analyzed, and it is desirable to control the image quality of the images feeding to the image processing system 78 or the predictive engine 74 for cost saving and time efficient purposes.

FIG. 3 is a plot 150 for a portion of a detailed record, such as a master log, generated by using the method 100. As illustrated in plot 150, the master log may include one or more curves to provide a record of one or more physical measurements (e.g., lithology) as a function of depth in the wellbore 20 of FIG. 1. The master log may include drilling information and drilling parameters, which are relevant to the geological and petrophysical interpretation of wellbore data.

As illustrated in FIG. 3, the plot 150 represents the lithology as a function of depth along a direction 152 (e.g., Z-axis) and corresponding lithology quantification along a direction of 154. The grayscale zones of the plot represent the categories of rocks that have been detected on the images of the rock samples at the corresponding depth. A legend 155 indicates which grayscale is associated with which category of rocks. For example, the plot 150 shows 4 rock categories, sandstone (e.g., located in an area 156), siltstone (e.g., located in an area 158), shales (e.g., located in an area 160), and “no match” category (e.g., located in an area 162), which indicates an unknown category.

The plot 150 may also include a confidence level plot 170, which corresponds to confidence of the prediction for each of the rock categories as a function of depth. Generally, lithology varies continuously in the wellbore. Therefore, based on the confidence level at each depth, depths having a lower confidence level may be corrected by comparing to neighboring depths associated with a higher confidence level. For instance, at a depth 172, the confidence level may have a relative low value with discrete variation from the confidence levels adjacent to it, both above and below. As illustrated in the plot 150, the rock category at the depth 172 is predicted with a high proportion of “no match”. Accordingly, the predicted rock category at the depth 172 may be corrected so that it matches the neighboring results with higher confidence levels, such as at the depth 174 with a confidence level of 84%. The correction described above may be applied to depths having a confidence level below a predetermined threshold and/or to the depths having a confidence level that is relatively low in view of the average confidence level of the whole wells.

The confidence level is closely related to the image quality of the rock samples. To obtain higher confidence level for a depth, high image quality of the rock samples in that depth may be desirable. In addition, using high quality images may increase the accuracy of the rock category prediction, which may reduce the “no match” category. Overall, using high quality images to identify lithology of the rock samples may substantially increase the accuracy of the lithology prediction. Moreover, using high quality images to identify lithology of the rock samples may substantially decrease the processing time since less time is used to process the images and correct the prediction of the rock categories.

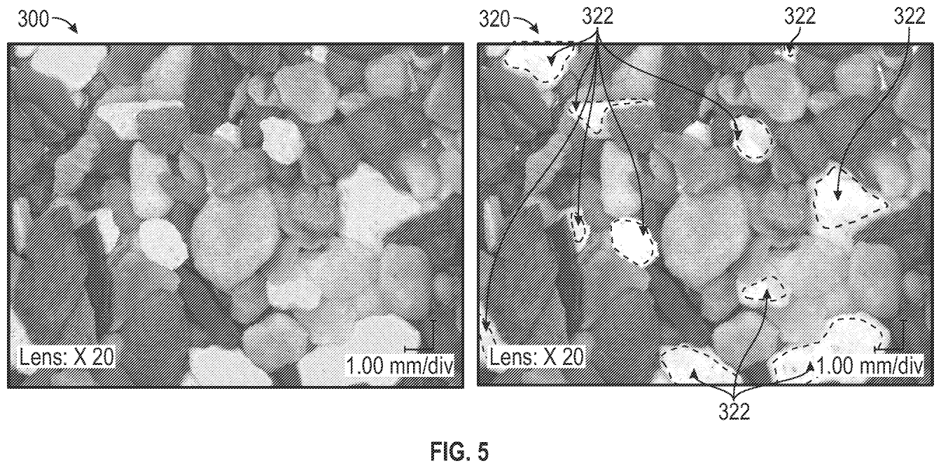

FIG. 4 is a is a flowchart of a computer-implemented method 200 for analyzing image quality used at the blocks 110 and 112 of the method 100 in FIG. 2. For example, the method 200 may be implemented using one or more processor-based systems (e.g., processor-based controllers) configured to control the drilling system 12, the imaging system 54, the analysis system 60, the image processing system 78, or any combination thereof. At block 202, the analysis system 60 may receive an image (e.g., digital image) of the rock samples from the imaging system 54. At block 204, the analysis system 60 may analyze the image of the rock samples to check the image quality by calculating multiple parameters associated with the image. The analysis system 60 may utilize the image processing system 78 to analyze the image of the rock samples. As mentioned above, one of the parameters associated with the image quality is the image saturation. When an image pixel is saturated, the differences in the light brightness of the image pixel may be difficult to detect. On the other hand, when the gray level is in a range close to the minimum value, changes in the gray level may also not correspond to changes in the light brightness of the image pixel. The analysis system 60 may analyze image pixels in the image data of the image to detect image pixels having gray levels in particular ranges close to the maximum value (e.g., 250-255) or the minimum value (e.g., 0-10). For image data including different color channels (e.g., red, green, blue, gray), the particular ranges may be determined for each color channel, or one or multiple combinations of the color channels. When the proportion of the image pixels having gray levels in the particular ranges (e.g., 250-255, 0-10) is greater than a threshold value, the image may not include sufficient information to identify the lithology of the rock samples. An example image having a portion of image pixels saturated is illustrated in FIG. 5.

FIG. 5 shows an image 300 without image saturation and an image 320 with a portion of image pixels saturated. In the image 320, multiple areas 322 correspond to areas of image pixels having gray levels in a range close to the maximum value (e.g., 250-255). As illustrated in FIG. 5, less information (e.g., color, luminance, texture) may be retrieved from the image pixels in the areas 322 since the changes of the gray levels of the image pixels in the areas 322 are not corresponding to the changes in the brightness of the image pixels. A proportion of the saturated image pixels may be determined by calculating the ratio of the total amount of image pixels in the multiple areas 322 to the total amount of image pixels of the image 320. For example, a higher ratio indicates more saturated image pixels in the image 320 while a lower ratio indicates less saturated image pixels in the image 320. When the proportion of the saturated image pixels is greater than a threshold (e.g., 40 percent, 50 percent), the image may not provide sufficient information to identify the lithology of the rock samples. The same method may be used to determine proportion of the image pixels having gray levels in a range close to the minimum value (e.g., 0-10).

Referring back to FIG. 4, at block 206, the analysis system 60 may compare the detected proportion of the image pixels having gray levels in the particular ranges (e.g., 250-255, 0-10) with corresponding threshold values. The threshold values for the particular ranges may be predetermined (e.g., based on operation requirements of the analysis system 60 or drilling targets). If the detected proportion of the image pixels having gray levels in the particular ranges (e.g., 250-255, 0-10) is not less than a threshold value, the analysis system 60 may output a notification (e.g., audio and/or visual alert), at block 208, indicating unacceptable gray levels of the image detected. The notification may be output to various systems (e.g., preparation device 52, imaging system 54, image processing system 78, predictive engine 74) to raise warning of the image with unacceptable gray levels. For example, based on the notification, the rock sample preparation in the preparation device 52 may be adjusted, the image processing system 78 may also adjust the parameters associated with image processing, and the predictive engine 74 may determine not to use the image in identifying lithology of the rock samples.

At block 210, the analysis system 60 may send an instruction to the imaging system 54 to calibrate the imaging system 54. The calibration may be determined based on the gray level ranges of the detected proportion. For example, the analysis system 60 may send instructions to the control device 58 to calibrate/adjust the lighting of the imaging system 54. For example, the control device 58 may adjust a shutter of the imaging device 56 to increase/decrease the light exposure of the image, or adjust light sources in the imaging system 54 to increase/decrease the ambient light of the imaging device 56, etc. If the detected proportion corresponds to gray levels in a range near the maximum gray level (e.g., 250-255), the control device 58 may reduce the shutter of the imaging device 56 to decrease the light exposure of the image, and/or decrease the intensities of the light sources in the imaging system 54 to decrease the ambient light of the imaging device 56, so that the detected proportion of the images may be reduced or eliminated. If the detected proportion having gray levels in a range near the minimum gray level (e.g., 0-10), the control device 58 may increase the shutter of the imaging device 56 to increase the light exposure of the image, and/or increase the intensities of the light sources in the imaging system 54 to increase the ambient light of the imaging device 56, so that the detected proportion of the images may be reduced or eliminated. After the imaging system 54 is calibrated/adjusted, the imaging system 54 may take another image of the rock samples. Thus, the blocks 202 to 210 may be repeated.

If the detected proportion of the image pixels having gray levels in the particular ranges (e.g., 250-255, 0-10) is less than a threshold value (e.g., indicating acceptable gray levels), the analysis system 60 may analyze the image data of the image to detect image blurriness at block 212. As mentioned above, another factor of image quality is image blurriness, which may be caused by a number of reasons, such as improper focus on the subject, motion of the camera and/or motion of the subject during exposure, etc. A blurry index may be used to describe the degree of blurriness. Various algorithms (e.g., Fast Fourier Transform (FFT), Single Value Decomposition (SVD) transform, Discrete Cosine Transform (DCT)) or software may be used to determine the blurriness of the image.

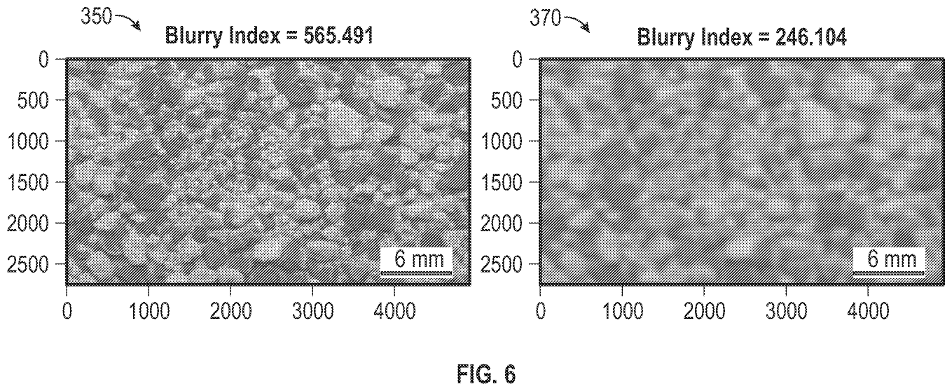

For instance, Laplacian operator may be used to determine local differentiation in gray levels. Thus, Laplacian operator may be applied to the image, and the results (e.g., statistical values) over the image may be used to determine the blurriness index of the image. For example, as illustrated in FIG. 6, when the local differentiation in gray levels is lower, the sharpness of the image is lower indicating the image is blurrier, and the blurry index is smaller; when the local differentiation in gray levels is greater, the sharpness of the image is greater indicating the image is less blurry, and the blurry index is greater. Other methods may be used to detect blurriness, such as applying a blurring filter (e.g., Gaussian filter) to the image.

FIG. 6 shows an image 350 with an acceptable blurry index (e.g., 565.491) greater than a threshold value (e.g., 500) and an image 370 with an unacceptable blurry index (e.g., 246.104) less than the threshold value. The visual characteristics (e.g., luminance and/or color) of the image 370, which has a relatively lower blurry index as compared to the image 350, may be difficult to detect because the local differentiation in gray levels is less noticeable.

Referring back to FIG. 4, at block 214, the analysis system 60 may compare the blurry index of the image with a first threshold value. For example, the first threshold value may be the minimum blurry index for the image to be used by the analysis system 60 (e.g., the predictive engine 74) to identify lithology of the rock samples.

If the blurry index is less than or equal to (e.g., not greater than) the first threshold, the analysis system 60 may compare the blurry index of the image with a second threshold value at block 216. For example, the second threshold value may be the minimum blurry index for the image to be corrected by the image processing system 78. If the blurry index is less than or equal to (e.g., not greater than) the second threshold, the analysis system 60 may proceed to block 208 (e.g., output the notification) and block 210 (e.g., calibrate the imaging system). The analysis system 60 may repeat the process of block 202 to block 216 until the blurry index is greater than the second threshold, otherwise, the analysis system 60 may exclude using the image in identifying the lithology of the rock samples.

If the blurry index is greater than the second threshold, the analysis system 60 may send the image to the image processing system 78 for correction at block 218. The blurry index of the corrected image may be compared with the first threshold value at block 214, and the process of block 214 to 218 may be repeated until the blurry index is greater than the first threshold. If the blurry index is greater than the first threshold, the analysis system may use it to identify lithology of the rock samples at block 220. As mentioned previously, the analysis system 60 may utilize the image processing system 78 to process the image to identify lithology of the rock samples. As mentioned previously, the analysis system 60 may also utilize the predictive engine 74 to identify lithology of the rock samples.

It should be noted that the above examples are for illustration. Although certain specific values or ranges (e.g., gray level 255, 250-255, 0-10) are used to describe disclosed embodiments, they should be understood as approximate values and may vary in different systems.

The techniques and system disclosed herein relate to utilizing automated image processing to detect and correct blurriness and saturated pixels in sample images, such as for cuttings obtained during drilling of a geologic formation. The results may be used to control related devices, such as the drilling system 12 and/or drilling plans of the drilling system 12 based on the lithology of the rock samples 47. The techniques and method disclosed herein may allow the acquisition of high quality logging curves for real-time and/or near real-time geologic formation evaluation and geosteering, which may be used to control the drilling process more efficiently and accurately. Although the examples described above are illustrated for wellbores on the land, similar method may be applied to any acquisition configuration.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
a processor; and
memory, accessible by the processor, and storing instructions that, when executed by the processor, cause the processor to perform operations comprising:
receiving image data of an image of rock samples from an imaging system, wherein the image data comprise a plurality of image pixels associated with a plurality of gray levels;
detecting a proportion of image pixels having gray levels in a particular range in the image data;
determining whether the image is qualified for an image analysis process by comparing the proportion with a threshold value;
in response to the determination that the image is qualified for the image analysis process, identifying lithology of the rock samples;
generating a record based on the lithology of the rock samples; and
controlling a device associated with acquiring the rock samples based on the record.

2. The system of claim 1, wherein the operations further comprise:
in response to the determination that the image is not qualified for the image analysis process, outputting a notification indicating an unacceptable image quality of the image; and
calibrating the imaging system.

3. The system of claim 2, wherein calibrating the imaging system comprises adjusting a parameter of a camera of the imaging system used to take the image, an operational condition of the camera, or both.

4. The system of claim 1, wherein the device comprises a component used by a drilling system, and wherein the rock samples are acquired by the drilling system from a plurality of depths of a wellbore.

5. The system of claim 1, wherein the operations further comprise:
calculating a blurriness index of the image using the image data;
comparing the blurriness index with a first threshold value; and
in response to the blurriness index is greater than the first threshold value, identifying the lithology of the rock samples.

6. The system of claim 5, wherein the operations further comprise:
applying a Laplacian operator to the plurality of image pixels of the image data for calculating the blurriness index of the image.

7. The system of claim 5, wherein the operations further comprise:
in response to the blurriness index is less than or equal to the first threshold value, comparing the blurriness index with a second threshold value; and
in response to the blurriness index is greater than the second threshold value, correcting the image to make the blurriness index greater than the first threshold value via an image processing system.

8. The system of claim 1, wherein a machine learning algorithm is used for identifying the lithology of the rock samples.

9. The system of claim 8, wherein historical wellbore formation data is used by the machine learning algorithm to identify the lithology of the rock samples.

10. A computer-implemented method, comprising:
receiving image data of an image of rock samples from an imaging system, wherein the image data comprise a plurality of image pixels associated with a plurality of gray levels;
detecting a proportion of image pixels having gray levels in a particular range in the image data;
determining whether the image is qualified for an image analysis process by comparing the proportion with a threshold value;
in response to the determination that the image is qualified for the image analysis process, identifying lithology of the rock samples;
generating a record based on the lithology of the rock samples; and
controlling a device associated with acquiring the rock samples based on the record.

11. The method of claim 10, further comprising:
in response to the determination that the image is not qualified for the image analysis process, outputting a notification indicating an unacceptable image quality of the image; and
calibrating the imaging system.

12. The method of claim 11, wherein calibrating the imaging system comprises:
adjusting a parameter of a camera of the imaging system used to take the image, an operational condition of the camera, or both.

13. The method of claim 10, further comprising:
calculating a blurriness index of the image using the image data;
comparing the blurriness index with a first threshold value; and
in response to the blurriness index is greater than the first threshold value,
identifying the lithology of the rock samples.

14. The method of claim 13, further comprising:
applying a Laplacian operator to the plurality of image pixels of the image data for calculating the blurriness index of the image.

15. The method of claim 13, further comprising:
in response to the blurriness index is less than or equal to the first threshold value, comparing the blurriness index with a second threshold value; and
in response to the blurriness index is greater than the second threshold value, correcting the image to make the blurriness index greater than the first threshold value via an image processing system.

16. The method of claim 10, further comprising:
using a machine learning algorithm for identifying the lithology of the rock samples.

17. A system, comprising:
a drilling system configured to acquire rock samples from a wellbore; and
a geological analysis system configured to identify lithology of the rock samples, wherein the geological analysis system comprises:
a preparation device configured to prepare the rock samples;
an imaging system configured to take an image of the rock samples; and
an analysis system configured to analyze an image quality of the image and identify lithology of the rock samples.

18. The system of claim 17, wherein the analysis system is further configured to adjust the imaging system based on the image quality of the image.

19. The system of claim 17, wherein the analysis system is configured to analyze the image quality of the image by using a convolution neural network with historical wellbore formation data associated with the wellbore.

20. The system of claim 17, wherein the analysis system is further configured to adjust the drilling system based on the lithology of the rock samples.
